(19) United States
(12) Patent Application Publication
(10) Pub. No.: US 2006/0196361 A1
(43) Pub. Date: Sep. 7, 2006

(54) SINGLE TOWER GAS DRYER WITH FLOWING DESICCANT STREAM

(76) Inventors: Terry D. Henderson, Naperville, IL (US); Charles A. Henderson, Wheaton, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/419,262

(22) Filed: May 19, 2006

Related U.S. Application Data
(63) Continuation-in-part of application No. 11/346,075, filed on Feb. 2, 2006.
(60) Provisional application No. 60/650,319, filed on Feb. 4, 2005.

(51) Int. Cl. B01D 53/02

(52) U.S. Cl. 96/148

(57) ABSTRACT

An apparatus and a method to remove adsorbates from a fluid is described. A fluid such as compressed air is passed over a desiccant in a drying tower to adsorb moisture from the compressed air. The desiccant is regenerated in a venturi. A pressure-equalization chamber can be located between the venturi and the drying tower, and a pressure-equalization chamber can be located between the drying tower and the venturi. In another embodiment, a heater is used to assist in regeneration. In yet another embodiment, a heat-of-compression dryer is used to assist in regeneration. In yet another embodiment, a storage chamber is used to store a batch of regenerated desiccant while a second batch of desiccant is being used.

### RELATED APPLICATION (PRIORITY CLAIM)

This application is a continuation-in-part of United States patent application Ser. No. 11/346,075, filed on Feb. 2, 2006, which claims the benefit of U.S. Provisional Application Ser. No. 60/650,391, filed on Feb. 4, 2005.

### BACKGROUND OF THE INVENTION

Compressed air is commonly used in various industrial facilities, such as to power tools or to operate instruments. The compression of air generally heats the air. Since all air contains at least some moisture, the compression process produces compressed air having moisture. The moisture remains a vapor at the temperature of the outlet air from the air compressor, but at the lower temperatures encountered in lines within a facility, the moisture in the compressed air, having a dew point within ambient temperatures, will condense and cause freezes, leaks, and corrosion with the system. Accordingly, dryers are conventionally used to lower the moisture content of compressed air. A standard rule for instruments is to lower the moisture content of the compressed air so that it has a dew point at least 10° C. (18° F.) below the lowest ambient temperature. Similar considerations apply to the compression of other gases.

Conventional dryers include two pressurized vessels or towers. Both towers contain a desiccant for adsorbing moisture from the air passed through the tower. In use, compressed air is passed through the first tower to provide dry compressed air. As desiccant in the first tower becomes wet and no longer capable of adsorbing moisture from the compressed air, the flow of compressed air is switched to the second tower. While the second tower processes the compressed air, the desiccant in the first tower is regenerated. When the desiccant in the second tower becomes saturated, the compressed air is again provided to the first tower for processing and the desiccant in the second tower is regenerated.

This arrangement requires at least two towers and a corresponding increase in capital costs, maintenance costs, and space costs. A simpler system using a single tower would provide advantages in lowering these costs, as well as in simplifying operations. The present invention provides these advantages.

### SUMMARY OF THE INVENTION

Briefly, and in accordance with the foregoing, the present invention is an apparatus and a method to remove adsorbates from a fluid. In the preferred embodiment, compressed air is passed over a desiccant in a drying tower to adsorb moisture from the compressed air. The desiccant is regenerated in a venturi. A pressure-equalization chamber can be located between the venturi and the drying tower, and a pressure-equalization chamber can be located between the drying tower and the venturi. In another embodiment, a heater is used to assist in regeneration. In yet another embodiment, a heat-of-compression dryer is used to assist in regeneration. In yet another embodiment, a storage chamber is used to store a batch of regenerated desiccant while a second batch of desiccant is being used.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a diagram of a heat of compression dryer in accordance with an embodiment of the present invention in which the desiccant is indirectly heated;

FIG. 1a is a detailed diagram of the connection between the desiccant supply tube and the depressurization tube of the dryer of FIG. 1;

FIG. 2 is a diagram of a heat of compression dryer in accordance with an embodiment of the present invention which can be used in connection with a lubricated compressor;

FIG. 3 is a diagram of a heat of compression dryer in accordance with an embodiment of the present invention in which the desiccant is directly heated;

FIG. 4 is a diagram of a heatless dryer in accordance with an embodiment of the present invention;

FIG. 5 is a diagram of a heated dryer in accordance with an embodiment of the present invention;

FIG. 6 is a diagram of a dryer in accordance with an embodiment of the present invention in which a portion of the processed air is used to regenerate the desiccant;

FIG. 7 is a diagram of an dryer in which a venturi is used to regenerate the desiccant;

FIG. 8 is a flow-sheet of the method used for the apparatus of FIG. 7; and

FIG. 9 is a diagram of another embodiment of a dryer in which a venturi dryer and a heater are used to regenerate the desiccant.

FIG. 10 is a diagram of yet another embodiment of a dryer in which a venturi and a heat-of-compression dryer are used to regenerate the desiccant.

FIG. 11 is a diagram of yet another embodiment of a dryer in which a storage chamber is used to store regenerated desiccant.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

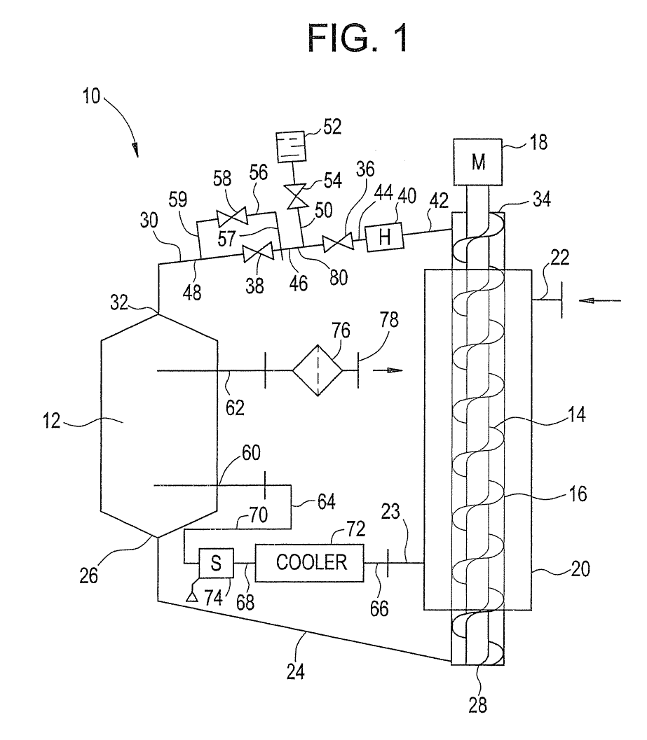

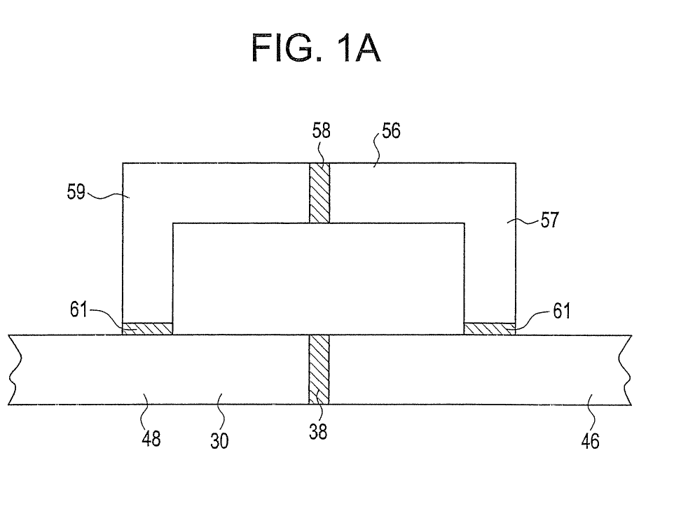

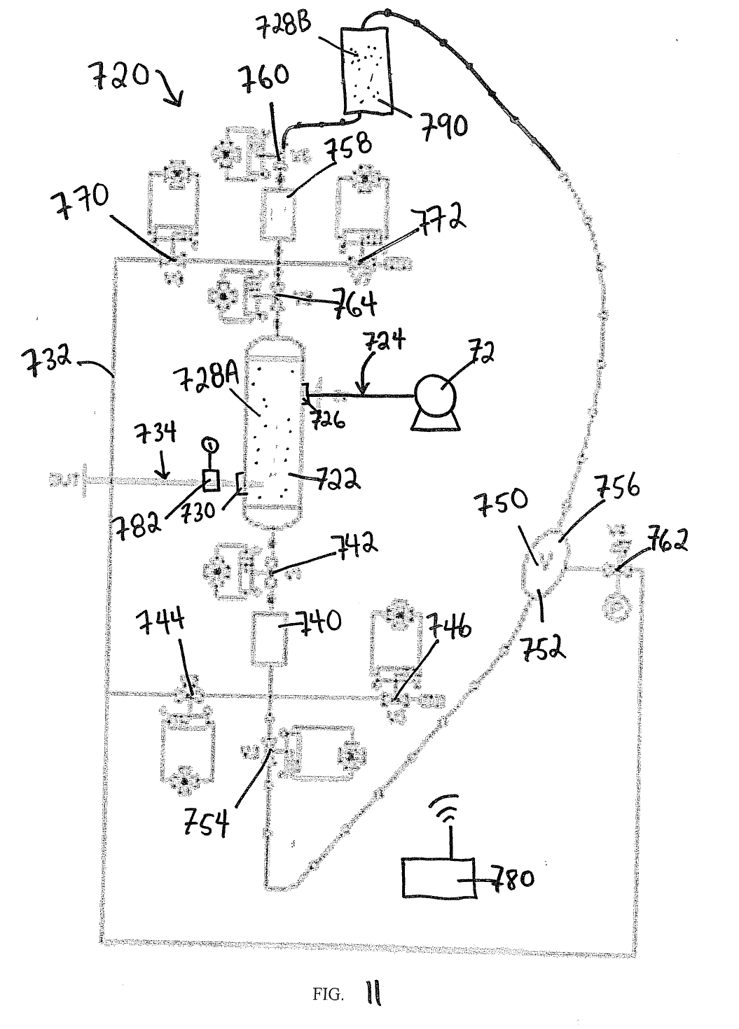

Different embodiments of the invention are shown in each of FIGS. 1 through 11.

As shown in FIG. 1, the heat of compression dryer 10 includes a standard gas drying vessel or tower 12 and an auger 14. The auger 14 is positioned within an interior pipe 16 and a motor 18 is connected to the auger 14 to rotate the auger 14. It is to be understood that the motor 18 could be connected to the auger at other locations, such as for example, the bottom of the auger 14. The core of the auger 14 may be solid or hollow. The interior pipe 16 and auger 14 are positioned within an exterior pipe or sleeve 20. The exterior pipe or sleeve 20 includes an inlet 22 and an outlet 23. Air from a compressor is received at the inlet 22.

A lower tube or desiccant removal tube 24 connects a bottom end desiccant outlet 26 of the tower 12 to a bottom end 28 of the interior pipe 16 containing the auger 14 and an upper tube or desiccant supply tube 30 connects a top end or desiccant inlet 32 of the tower 12 to a top end 34 of the interior pipe 16 containing the auger 14. The desiccant removal tube 24 is downwardly inclined such that gravity will cause material to flow from the bottom end 26 of the tower 12 to the bottom end 28 of the auger 14. The desiccant supply tube 30 is downwardly inclined such that gravity will cause material to flow from the top end 34 of the auger 14 to the top end 32 of the tower 12.

A desiccant-in valve 36, such as, for example, a rotary lock, a desiccant-out valve 38, such as, for example, a rotary lock, and a heater 40 are mounted along the desiccant supply tube 30. The desiccant supply tube 30 includes a first portion 42, a second portion 44, a third or regeneration portion 46 and a fourth portion 48. The first portion 42 extends from the top end 34 of the interior pipe 16 to the heater 40. The second portion 44 extends from the heater 40 to the desiccant-in valve 36. The third or regeneration portion 46 extends from the desiccant-in valve 36 to the desiccant-out valve 38. The fourth portion 48 extends from the desiccant-out valve 38 to the upper end 32 of the vessel 12.

A muffler tube 50 extends upwardly from the third portion 46 of the desiccant supply tube 30 and provides an outlet for wet gas. A muffler 52 is provided at an end of the muffler tube 50 opposite the third portion 46. A depressurization valve 54 is provided along the muffler tube 50 between the third portion 46 of the desiccant supply tube 30 and the muffler 52.

A re-pressurization tube 56 extends from the third portion 46 of the desiccant supply tube 30 to the fourth portion 48 of the desiccant supply tube 30. A re-pressurization valve 58 is provided along the re-pressurization tube 56. The re-pressurization tube 56 includes a first portion 57 extending from the third portion 46 of the desiccant supply tube 30 to the re-pressurization valve 58 and a second portion 59 extending from the re-pressurization valve 58 to the fourth portion 48 of the desiccant supply tube 30. A detailed view of the connection between the desiccant supply tube 30 and the re-pressurization tube 56 is shown in FIG. 1a. As shown in FIG. 1a, the re-pressurization tube 56 contacts the upper surface of the desiccant supply tube 30. In addition, a screen or filter 61 is provided at either end of the re-pressurization tube 56 to prevent desiccant from entering the re-pressurization tube 56. Preferably, the screen 61 is formed from perforated stainless steel.

As shown in FIG. 1, a chamber 80 is provided by the third portion 46 of the desiccant supply tube 30, the first portion 57 of the re-pressurization tube 56, and the depressurization tube 50.

The tower 12 includes a gas inlet 60 and a gas outlet 62. An incoming tube 64 is provided between the inlet 60 of the tower 12 and the outlet 23 of the outer pipe or sleeve 20. The incoming tube 64 includes a first portion 66, a second portion 68, and a third portion 70. A cooler 72 and a moisture separator 74 are provided along the incoming tube 64. The cooler 72 is positioned between the first portion 66 and the second portion 68 of the incoming tube 64. The moisture separator 74 is positioned between the second portion 68 and the third portion 70 of the incoming tube 64. Drain traps 75 are attached to the separator 74 to remove liquid water from the dryer.

An after filter 76 is provided at the outlet 62 of the tower 12 and the dryer outlet 78 is provided by the after filter 76.

In operation, desiccant flows throughout the dryer 10. The desiccant in tower 12 adsorbs moisture from gas suppled to the tower 12 through the inlet 60. Dried gas exits the tower 12 at the outlet 62. Wet desiccant generally flows from the bottom end 26 of the tower 12 through the desiccant removal tube 24 to the bottom end 28 of the interior pipe 16. The auger 14 carries the wet desiccant upward to the top end 34 of the interior pipe 16. The desiccant exits the top end 34 of the interior pipe 16 and flows through the desiccant supply tube 30 to the top end 32 of the tower 12. Hot compressed air is provided to the outer sleeve 20, through the inlet 22, where heat from the compressed air heats the desiccant within the interior pipe 16 and air surrounding the desiccant as the auger 14 moves the desiccant upwardly through interior pipe 16. If the auger 14 has a hollow core, hot air can be provided to the core of the auger to further heat the desiccant as it moves upwardly through the interior pipe 16. The heated desiccant then flows through the desiccant supply tube 30 toward the upper end 32 of the tower 12. Before reaching the upper end 32 of the tower 12, a pressurizing and de-pressurizing cycle is carried out by the valves 36, 38, 54, 58 to remove moisture from the heated desiccant before it flows into the tower 12.

Hot wet desiccant exits the upper end 34 of the auger 14 and flows through the first portion 42 of the desiccant supply tube 30 and is passed through the heater 40. The heater 40 is an optional auxiliary heater which can be used to raise the temperature of the desiccant to temperatures higher than possible through the inlet gas alone. The moisture is removed from the desiccant during the depressurizing-re-pressurizing cycle.

Cycling of the valves begins with the desiccant-in, desiccant-out, and depressinization valves 36, 38, 54 in the closed position and the re-pressurization valve 58 in the open position. The desiccant-out valve 38 is then opened to allow the desiccant in the third or regeneration portion 46 of the desiccant supply tube 30 to flow into the tower 12. The desiccant-out valve 38 and the re-pressurization valve 58 are then closed. Next, the desiccant in valve 36 is opened to allow wet desiccant to enter the third or regeneration portion 46 of the desiccant supply tube 30. Because the re-pressurization tube 56 is positioned above the desiccant supply tube 30, desiccant does not flow from the desiccant supply tube 30 into the re-pressurization tube 56. The desiccant-in valve 36 is then closed to isolate the desiccant in the third portion 46 of the desiccant supply tube 30. The depressurization valve 54 is opened, depressurizing the air in the regeneration portion 46 of the desiccant supply tube 30. The re-pressurization valve 58 is then opened and dry, compressed air flows from the upper end 32 of the vessel 12, through the fourth portion 48 of the desiccant supply tube 30, through the second portion 59 of the re-pressurization tube 56, through the repressurization valve 58, through the regeneration portion 46 of the desiccant supply tube 30 and through the depressurization valve 54 to remove moisture from the chamber 80 and to vent the moisture through the muffler or wet gas outlet 52. The amount of time the repressurization valve 58 remains open can be varied. The filter 61 mounted between the fourth portion 48 of the desiccant supply tube 30 and the second portion 59 of the re-pressurization tube 56 prevents desiccant from entering the re-pressurization tube 56. The de-pressurization valve 54 is then closed to re-pressurize the chamber 80. The desiccant-out valve 38 is opened and dry desiccant is provided to the tower 12 and the cycle begins again. This depressurizing-re-pressurizing cycle removes the moisture from the desiccant and the air surrounding the desiccant and occurs approximately every 5 seconds. The length of time of this cycle, can be adjusted for the particular cycle desired.

The dried desiccant passes through the desiccant-out valve 38 to the upper end 32 of the tower 12. Compressed air exits the outer pipe 20 at the outer pipe outlet 23 where it is carried to the cooler 72 and then to the moisture separator 24 prior to entering the tower 12. The compressed air enters the tower 12 through the tower inlet 60 and exits the tower 12 at the tower outlet 62. As the compressed air is passed through the tower 12, the desiccant within the tower 12 removes moisture from the air. Upon exiting the tower 12 through the tower outlet 62 the air is passed through an after filter 76 to remove any particles of desiccant from the air. Dry processed compressed air is provided at the outlet of the after filter 76.

As the desiccant moves through the tower 12, the desiccant becomes wet and it can no longer effectively remove moisture from the air within the tower 12. The wet desiccant exits the desiccant outlet 26 of the tower 12 and flows through the desiccant removal tube 24 to the lower end 28 of the interior pipe 16. Heat from the compressed air which enters the outer pipe 20, heats the interior pipe 16 and desiccant within the interior pipe 16 and the auger 14 carries the desiccant upward through the interior pipe 16 to the top end 34 thereof. The desiccant is then passed through the depressurization-re-pressurization cycle to complete the regeneration of the desiccant.

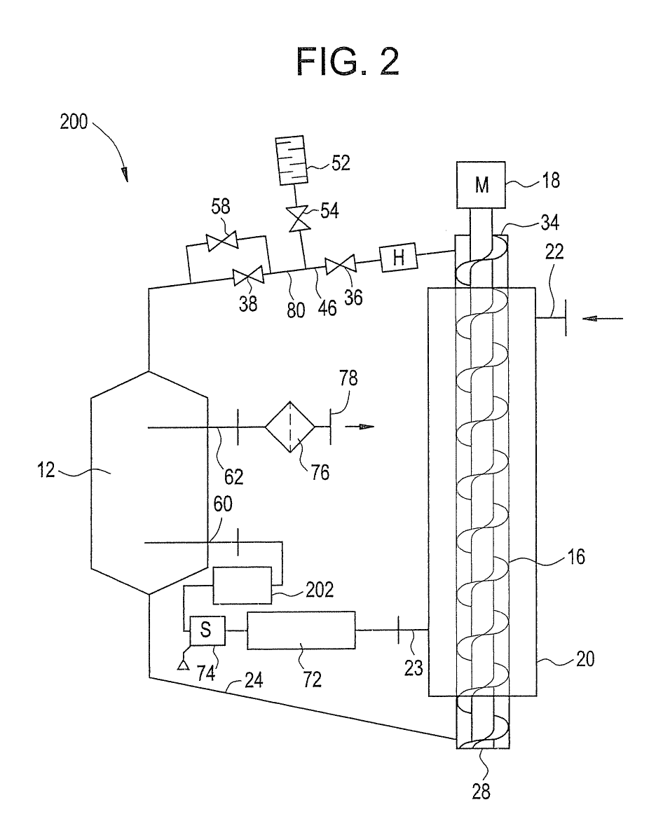

A second embodiment of the invention is shown in FIG. 2. The dryer 200 is identical to the dryer 10 with the following exception. The dryer 200 includes a coalescing pre-filter 202 between the moisture separator 74 and the tower inlet 60. With the coalescing pre-filter 202, the dryer 200 can be used in connection with a lubricated compressor. When a lubricated compressor is attached to the dryer inlet 22, the pre-filter 202 removes oil from the air after the air has been cooled by the cooler 72 and processed by the moisture separator 74 and before the air enters the tower 12.

Compressed air enters the inlet 22 of the exterior pipe 20 from a lubricated compressor (not shown). The wall of the interior pipe 16, prevents the compressed air from contacting the desiccant within the interior pipe 16 as the auger 14 carries the desiccant upward through the interior pipe 16. Although the compressed air does not contact the desiccant within the interior pipe 16, heat from the compressed air is carried to the desiccant through the wall of the interior pipe 16. Compressed air exits the exterior pipe 20 at the outlet 23 where it is then passed through the cooler 72, the moisture separator 74, the pre-filter 202, and then to the inlet 60 of the tower 12. The pre-filter 202 acts to remove oil from the compressed gas before the compressed gas enters the tower 12 and contacts the desiccant.

Use of an oil flooded or lubricated compressor in comparison to an non-lubricated compressor reduces the amount of energy required to regenerate the desiccant. Removing oil from air at high temperatures can be difficult. However, because the temperature of the air is reduced prior to passing the air through the pre-filter 202, the oil can be removed from the air without the complications associated with removing oil from the air at higher temperatures.

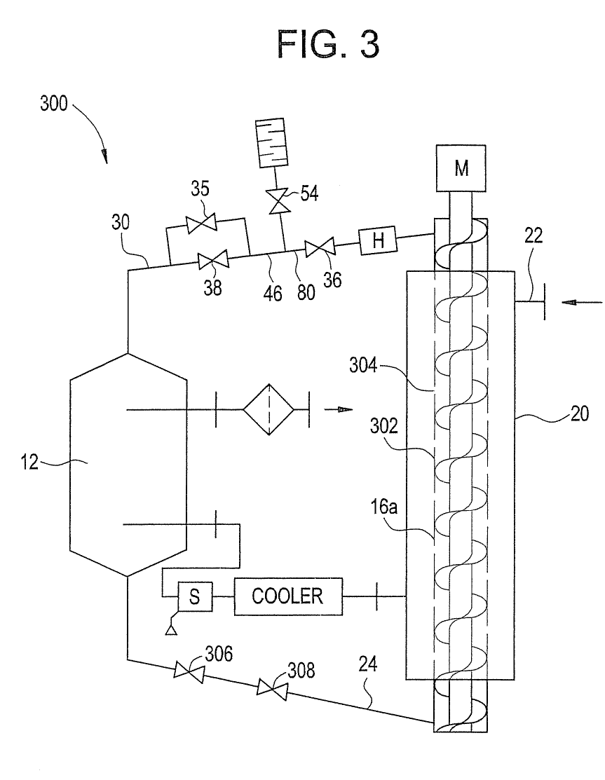

A third embodiment of the dryer is shown in FIG. 3. The dryer 300 is identical to the dryer 10 shown in FIG. 1 with the following exceptions. Unlike the dryer 10 which includes an interior pipe 16 formed from a solid wall, the wall 302 of the interior pipe 16a is perforated. Thus, a plurality of holes 304 are dispersed along the wall 302. In addition, the dryer 300 includes valves or rotary locks 306, 308 along the lower tube 24. The rotary locks 306, 308 operate in the same sequence as the desiccant-in and desiccant-out valves 36, 38. Thus, when desiccant-in valve 36 is open, valve 306 is open. When desiccant-in valve 36 is closed, valve 306 is closed. When desiccant-out valve 38 is open, valve 308 is open and when desiccant-out valve 38 is closed, valve 308 is closed.

In operation, as compressed air enters the inlet 22 of the exterior pipe 20, the compressed air passes through the holes 304 of the wall 302 of the interior pipe 16 and comes in direct contact with the desiccant being carried upward by the auger 14. The desiccant within the interior pipe 16a, therefore, is directly heated by the compressed air.

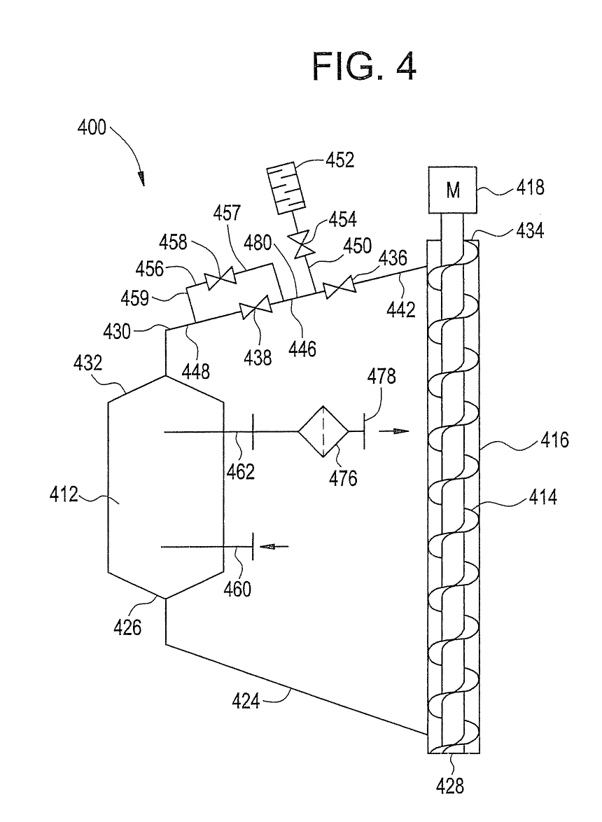

A fourth embodiment of the dryer is shown in FIG. 4. As shown in FIG. 4, the dryer 400 is a heatless model. The dryer 400 includes a standard gas drying vessel 412 and an auger 414. The auger 414 is positioned within a pipe 416 and a motor 418 is connected to the auger 414 to rotate the auger 414. A lower tube or desiccant removal tube 424 connects a bottom end or desiccant outlet 426 of the tower 412 to a bottom end 428 of the pipe 416 containing the auger 414 and an upper tube or desiccant supply tube 430 connects a top end or desiccant inlet 432 of the tower 412 to a top end 434 of the pipe 416 containing the auger 414. The lower tube 424 is downwardly inclined such that gravity will cause the material to flow from the bottom end 426 of the tower 412 to the bottom end 428 of the pipe 416. The desiccant supply tube 430 is downwardly inclined such that gravity will cause material to flow from the top end 434 of the auger 414 to the top end 432 of the tower 412.

A desiccant-in valve 436 and a desiccant-out valve 438 are mounted along the desiccant supply tube 430. The desiccant supply tube 430 includes a first portion 442, a second or regeneration portion 446, and a third portion 448. The first portion 442 extends from the top end 434 of the pipe 416 to the desiccant-in valve 436. The second portion 446 extends from the desiccant-in valve 436 to the desiccant-out valve 438. The third portion 448 extends from the desiccant-out valve 438 to the top end 432 of the tower 412.

A muffler tube 450 extends upwardly from the second or regeneration portion 446 of the desiccant supply tube 430. A muffler 452 us provided at the end of the muffler tube 450 opposite the second portion 446 of the desiccant supply tube 430. A depressurization valve 454 is provided along the muffler tube 450 between the second portion 446 of the desiccant supply tube 430 and the muffler 452.

A re-pressurization tube 456 extends from the second portion 446 of the desiccant supply tube 430 to the third portion 448 of the desiccant supply tube 430. The re-pressurization tube 456 includes a first portion 457 and a second portion 459. A re-pressurization valve 458 is provided between the first portion 457 and the second portion 459 of the re-pressurization tube 456. In the same manner as described with respect to the first embodiment of the invention, the re-pressurization tube 456 contacts the upper surface of the desiccant supply tube 430 to prevent desiccant from entering the re-pressurization tube 456.

A chamber 480 is provided by the second portion 446 of the desiccant supply tube 430, the first portion 457 of the re-pressurization tube 456, and the depressurization tube 450.

The tower 412 includes a gas inlet 460 and a gas outlet 462. An after filter 476 is provided at the outlet 462 of the tower 412 and the dryer outlet 478 is provided by the after filter 476.

In operation, desiccant flows throughout the dryer 400. The desiccant generally flows from the bottom end or desiccant outlet 426 of the tower 412, through the lower tube 424, to the bottom end 428 of the auger 414. The auger 414 carries the desiccant upward to the top end 434 of the auger 414. The desiccant exits the top end 434 of the auger 414, flows through the desiccant supply tube 430 to the top end or desiccant inlet 432 of the tower 412. Before reaching the tower 412, a pressurizing-de-pressurizing cycle identical to the pressurizing-de-pressurizing cycle described in connection with the first embodiment of the invention is carried out by the valves 436,438,454, and 458 to remove moisture from the desiccant before it flows into the tower 412.

The dried desiccant passes through the desiccant-out valve 438 to the upper end 432 of the tower 412. Compressed air enters the tower 412 through the tower inlet 460 and exits the tower 412 at the tower outlet 462. As the compressed air is passed through the tower 412, the desiccant within the tower 412 removes moisture from the air. Upon exiting the tower 412 through the tower outlet 462 the air is passed through an after filter 476 to remove any particles of desiccant from the gas. Dry processed compressed gas is provided at the outlet 478 of the after filter 476. If the dryer 400 is to be used in connection with a lubricated compressor, a coalescing pre-filter and a cooler can be provided at the tower inlet 460 to remove any oil from the compressed air.

As the desiccant moves through the tower 412, the desiccant becomes wet and it can no longer effectively remove moisture from the air within the tower 412. The wet desiccant exits the lower end 426 of the tower 412 and flows through the lower tube 424 to the lower end 428 of the pipe 416. The auger 414 carries the desiccant to the upper end 434 of the pipe 416. The desiccant is then passed through the depressurization-re-pressurization cycle to complete the regeneration of the desiccant.

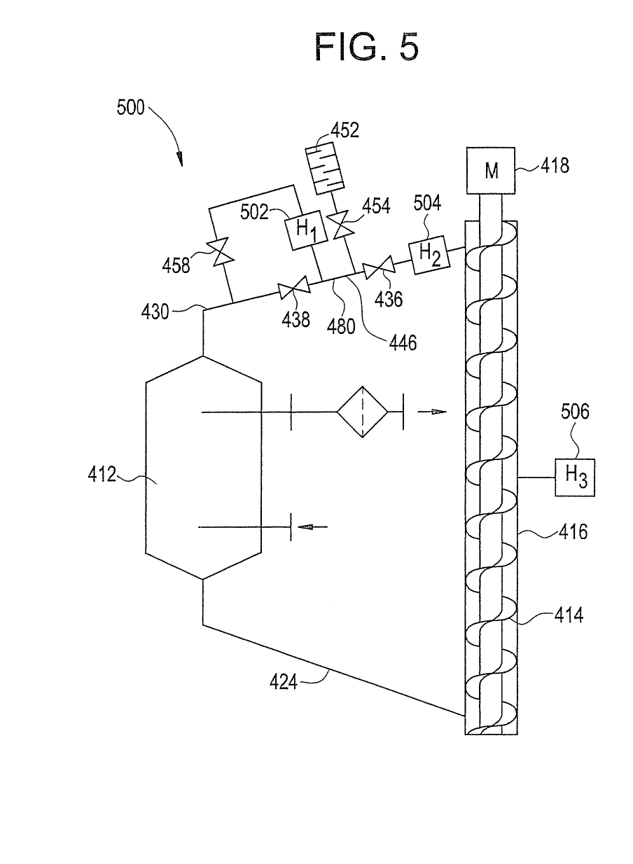

A fifth embodiment of the dryer is shown in FIG. 5. As shown in FIG. 5, the dryer 500 is a heated model. The dryer 500 is identical to the dryer 400 with the following exceptions. The dryer 500 includes a heater. Three alternative locations (502, 504, 506) for the heater are shown in FIG. 5. Alternatively, heaters may be used at multiple locations.

Heater 502 is positioned between the re-pressurization valve 458 and the second portion 446 of the desiccant supply tube 430. As with the dryer 400, a depressurization-re-pressurization cycle of the valves 436, 438, 454, and 458 is used to removed moisture from the air and desiccant within the chamber 480. Dining the re-pressurization portion of the cycle (i.e. when the desiccant-in, desiccant-out, and depressurization valves 436, 438, 454 are closed and the re-pressurization valve 458 is opened, the heater 502 is used to raise the temperature of the air within the chamber 480 to approximately 300 degrees Fahrenheit. By increasing temperature of the air within the chamber 480, the length of time need to dry the desiccant within the chamber 480 is reduced relative to the dryer 400.

Heater 504 is positioned between the upper end of the pipe 416 and the desiccant-in valve 436. In this location the heater 504 is used to raise the temperature of the desiccant prior to the desiccant entering the chamber 480.

Heater 506 is positioned along the wall of the pipe 416 containing the auger 414. In this location, the desiccant is heated as it is moved upwardly within the pipe 416.

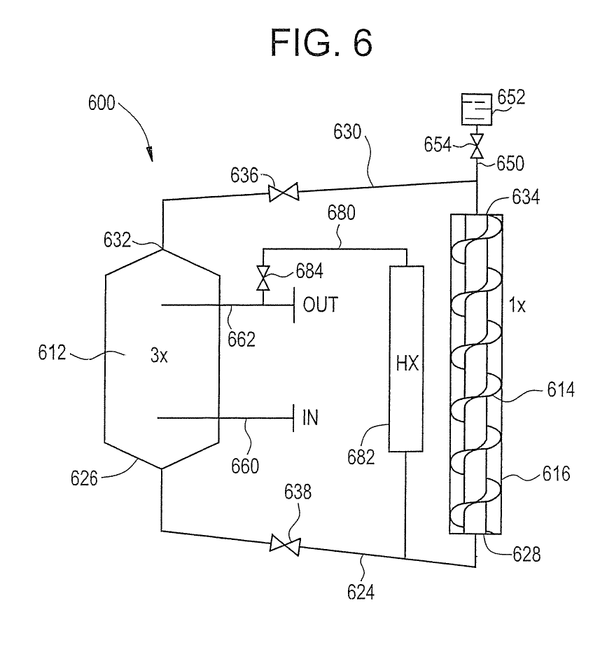

A sixth embodiment of the dryer is shown in FIG. 6. As shown in FIG. 6, the dryer 600 includes a tower 612, an auger 614, a pipe 616, a heater 682, an desiccant supply tube 630, a lower tube 624, and a muffler 652.

The tower 612 has an upper end or desiccant inlet 632 and a lower end or desiccant outlet 626. The tower 612 also includes a gas inlet 660 and a gas outlet 662. The pipe 616 has an upper end 634 and a lower end 628. The auger 614 is provided within the pipe 616. A muffler tube 650 extends from the upper end of the pipe 616 and a muffler 652 is provided at the outer end of the muffler tube 650. A depressurization valve 654 is provided along the muffler tube 650 between the muffler 652 and the upper end 634 of the pipe 616.

The upper tube or desiccant supply tube 630 extends from the upper end 634 of the pipe 616 to the upper end or desiccant inlet 632 of the tower 612. The desiccant supply tube 630 is downwardly inclined such that gravity causes material to flow from the upper end 634 of the pipe 616 through the desiccant supply tube 630 to the upper end 632 of the tower 612. A desiccant-in valve 636 is provided along the desiccant supply tube 630. The lower tube 624 is downwardly inclined such that gravity causes material to flow from the lower end 626 of the tower 612 to the lower end 628 of the pipe 616. A desiccant-out valve 638 is provided along the lower tube or desiccant removal tube 624.

A dried gas tube 680 is provided from the outlet 662 of the tower 612 to the desiccant removal tube 624. The heater 682 is provided along the dried gas tube 680. A dried gas valve 684 is provided between the outlet 662 of the tower 612 and the heater 682.

In operation, compressed air is supplied through the inlet 660 to the tower 612 where the air is dried by desiccant provided within the tower 612. The dry processed air exits the tower 612 at the tower outlet 662. Processed air is also passed through the dried gas valve 684, through the dried gas tube 680, and to the heater 682 where the air is heated. The heated air is then supplied to the desiccant removal tube 624 and is then passed to the lower end 628 of the pipe 616. The auger 614 within the pipe 616 carries the desiccant upward through the pipe 616 to fill the pipe 616. As the desiccant is heated, moisture in the desiccant forms steam. The steam passes through the muffler tube 650, through the depressurization valve 654, and through the muffler 652 where it is vented to the atmosphere. The dried, regenerated desiccant flows out of the top end 634 of the pipe 616 through the desiccant supply tube 630 and to the top end 632 of the tower 612 where it is again used to dry the compressed air.

Sequencing of the valves 636, 638, 650 and 684 results in processing of the desiccant in a batch fashion. Sequencing of the valves is as follows. The cycle begins with the desiccant-in and desiccant-out valves 636, 638 in the open position and depressurization valve 654 and the heater valve 684 in the closed positions. The desiccant-in valve 636 and the desiccant out valve 638 remain open for a period of time to allow desiccant to fill the pipe 616. Once the pipe 616 is fill, the desiccant-in and desiccant-out valves 636, 638 are closed, and the depressurization valve 650 is opened to depressurize the pipe 616. Next, the dried gas valve 684 is opened to begin regeneration of the desiccant within the pipe 616. At this time, the heater is turned on and the auger is turned off. Dry air from the outlet 662 of the tower 612 is provided to the heater 682 and is passed to the pipe 616 where it regenerates the desiccant within the pipe 616. Hot moist air exits the pipe 616, through the muffler tube 650, and is vented to the atmosphere through the muffler 652. Once the desiccant in the pipe 616 is regenerated, the depressurization valve 654 is closed and heater valve 684 is closed. Finally, the desiccant-in and desiccant-out valves are opened to begin the cycle again.

In another embodiment of the present invention, a pneumatic conveyor is used to move desiccant. For example, in any of FIGS. 1 through 6, a pneumatic conveyor can be used in place of auger 14, 414, and 416.

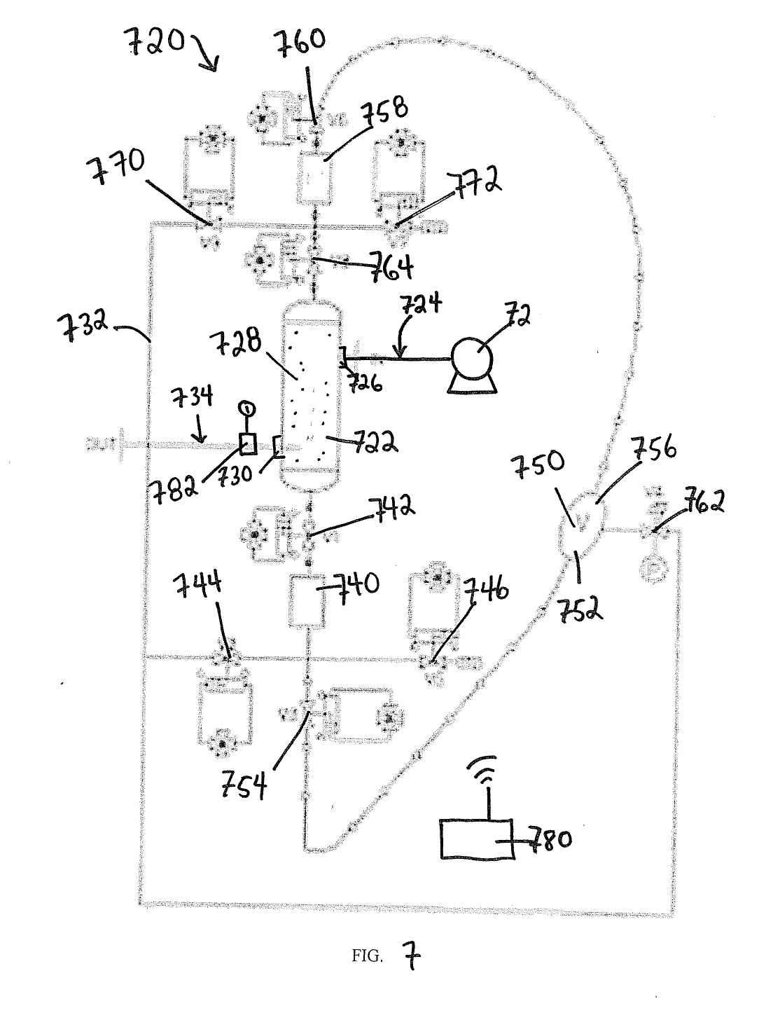

Particular embodiments of a pneumatic conveyor system will now be described. In the embodiments shown in FIGS. 7 through 11, dryer 720 uses a venturi to pneumatically convey and to regenerate desiccant from a single-tower dryer. These embodiments will be described as used in the particular example of removing water from compressed air. These embodiments, however, can be used on any fluid to remove a adsorbate from the fluid. Accordingly, in the following description, the fluid is compressed air, but the invention can be used on another compressed gas or on a liquid. In the case of air or other gases, the fluid is produced by a compressor, but in the case of a liquid, the fluid is pumped. In the case of the removal of moisture from air, the adsorbate is water and the adsorbent is a desiccant, preferably beads of alumina, most preferably three-sixteenths-inch spherical activated almina. Other adsorbents are used to remove impurities or contaminants from other gases. Accordingly, as used herein, “desiccant” means any solid material having the properties of adsorption.

In the embodiment illustrated in FIG. 7, dryer 720 has a single tower 722 for removing moisture from wet compressed air 724. Wet compressed air 724, produced in compressor 725, flows into inlet 726 of a removal chamber, tower 722, flows over beads of initially dry desiccant 728, exits tower 722 at outlet 730, and flows into compressed air line 732 as dry compressed air 734.

Tower 722 is preferably of the downflow-drying type, so that air 724 enters near the top of tower 722 and air 734 exits near the bottom. By this arrangement, beads of desiccant 728 move through tower 722 by gravity. Other arrangements as are known in the art can be used. As wet compressed air 724 flows over desiccant 728, moisture in air 724 adsorbs onto desiccant 728 so that desiccant 728 becomes an adsorbed desiccant. The moisture adsorbed onto desiccant 728 will be de-adsorbed, to produce regenerated desiccant, as will hereinafter be described.

A lower pressure-equalization chamber 740 is connected to tower 722, with valve 742 located therebetween. Chamber 740 is also connected to air line 732 through valve 744 and to atmosphere through valve 746. Accordingly, chamber 740 can be pressurized to line pressure, for example, one-hundred psi, through valve 744, before receiving adsorbed desiccant 728 from tower 722, in order to minimize damage to the beads as they enter chamber 740.

Venturi 750 receives adsorbed desiccant 728 from chamber 740 and acts as a regenerator to remove adsorbate from desiccant 728. Venturi 750 is connected at its entry cone 752 to chamber 740 through valve 754. Venturi 750 is connected through its exit cone 756 to an upper pressure-equalization chamber 758 through valve 760. Venturi 750 is connected to air line 732 through valve 762. Venturi 750 preferably has an entry cone 752 of approximately thirty degrees and an exit cone 756 of approximately five degrees.

Chamber 758 is preferably located above tower 722, in order to gravity-feed regenerated desiccant 728 into tower 722 through valve 764. Chamber 758 is connected to air line 732 through valve 770. Chamber 758 is connected to atmosphere through valve 772.

Valves 742, 744, 746, 754, 760, 762, 764, 770, and 772 are preferably air-actuated and operate in a conventional manner, using air pressure from air line 732. In the preferred embodiment, all valves are controlled by a central controller 780. Controller 780 can be an analog controller, a microprocessor, or other controller as is known in the art. Controller 780 comprises communication structure sufficient to control each valve in dryer 720 in accordance with the principles of the present invention. In the illustrated embodiment, controller 780 controls all valves wirelessly. In other embodiments, controller 780 is hard-wired to each valve. In yet another embodiment, all valves are controlled manually by human operators.

Controller 780 preferably monitors humidity detector 782. Controller 780, in this embodiment, upon determining, based on the humidity of dry pressurized air 734, that desiccant 728 within tower 722 is close to being saturated, operates valves 742, 744, 746, 754, 760, 762, 764, 770, and 772 to regenerate desiccant 728. In another embodiment, controller 780 is programmed to start the regeneration cycle after passage of a predetermined amount of time. Other programming modes are possible. For example, the degree of saturation of desiccant 728 at which the regeneration cycle begins is controllable by the user depending on the ambient air temperatures of the facility in which dryer 720 is used, or the end use of dry compressed air 734.

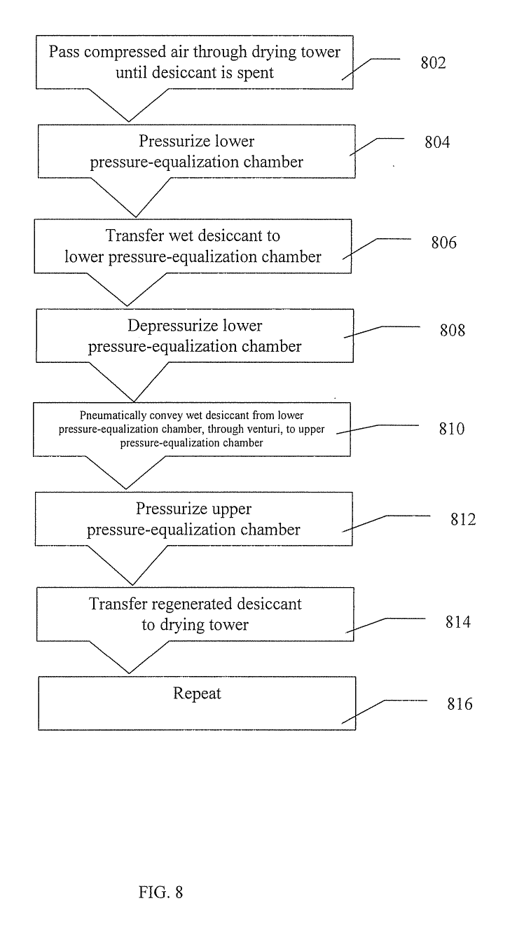

The operation of dryer 720 will now be described. The operation is shown in flow-sheet format in FIG. 8. Wet pressurized air 724 enters tower 722 through inlet 726 from compressor 725. Moisture in air 724 is adsorbed onto desiccant 728, so dry pressurized air 734 exits tower 722 through outlet 730 and flows into air line 732 (step 802). Air 734 in air line 732 is used to power plant instruments, tools, or whatever end uses require dry compressed air. Air 734 is also used to operate dryer 720.

During the time period in which air 724 is being dried in tower 722, valves 764 and 742 are closed. Tower 722 accordingly operates at close to line pressure.

When desiccant 728 becomes saturated, or close enough to saturated that its effectiveness is diminished, or after a predetermined time period, the regeneration cycle begins. Valve 744 opens to pressurize chamber 740 to line pressure (step 804). At this point, valves 754 and 746 are closed. When chamber 740 has been pressurized to line pressure, valve 744 closes and valve 742 opens, discharging adsorbed desiccant 728 from tower 722 into chamber 740 (step 806). When tower 722 is empty, valve 742 closes. Please note that tower 722 remains at line pressure.

To regenerate desiccant 728, valve 746 vents to atmosphere to depressurize chamber 740 (step 808). When chamber 740 is fully depressurized, valves 754, 760, and 772 are opened and venturi 750 is actuated through valve 762. Adsorbed desiccant 728 is thereby pneumatically conveyed from chamber 740 to chamber 758 (step 810). As adsorbed desiccant 728 passes through venturi 750, the rapid decrease in pressure causes de-adsorption of the moisture carried on the beads of desiccant 728, thereby producing regenerated desiccant. Regenerated desiccant 728, as it flows into chamber 758, which at this point is vented to atmosphere, is relatively dry and ready for use.

When the entire batch of desiccant 728 has been transferred from chamber 740 to chamber 758, air pressure to venturi 750 is shut off by closing valve 762. Valves 754 and 746 are closed to seal off chamber 740. Valves 760 and 772 are closed to seal off chamber 758. Valve 770 is opened to re-pressurize chamber 758 to line pressure (step 812).

When chamber 758 reaches line pressure, valve 770 closes. Valve 764 then opens to discharge regenerated desiccant 728 into tower 722 (step 814). When chamber 758 is empty, valve 764 closes to seal tower 722. Regenerated desiccant 728 resumes adsorbing moisture from wet pressurized air 724 (step 802). When desiccant 728 is saturated or closed to being saturated, as determined by detector 782, or after a predetermined time period, the process begins again.

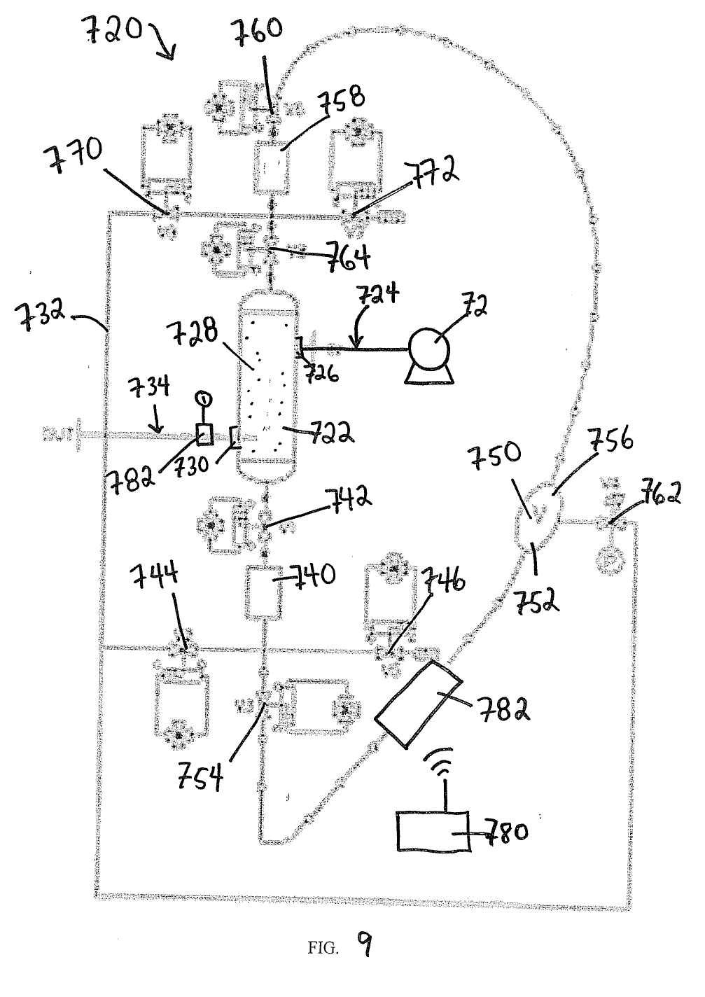

In another embodiment, a heater 784 is used to enhance regeneration. Heater 782, as shown in FIG. 9, is preferably located between chamber 740 and venturi 750.

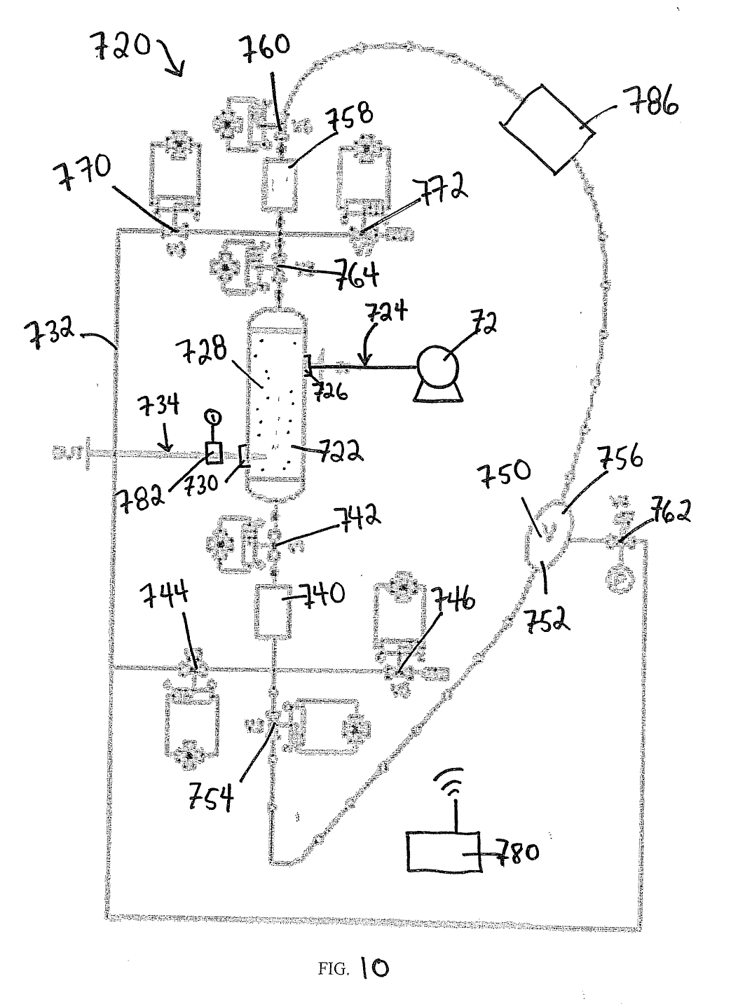

In yet another embodiment, a heat-of-compression dryer 786 is used to assist regeneration of desiccant 728. In this embodiment, as shown in FIG. 10, heat-of-compression dryer 786 is located between venturi 750 and chamber 758, as shown in FIG. 3. Heat-of-compression dryer 786 is preferably one as described in connection with any of FIGS. 1 through 6.

In another embodiment, a storage chamber 790 is interposed between venturi 750 and chamber 758, as shown in FIG. 10. In this embodiment, a first batch of wet desiccant 728A from chamber 740 is regenerated by passing through venturi 758, as described above, but is then deposited in storage chamber 790. During the time period that first batch 728A is undergoing regeneration, a second batch of dry desiccant 728B is transferred, as described above, from chamber 758 to tower 722. When chamber 758 has been emptied, and first batch 728A has been fully regenerated using the process previously described, first batch 728A is transferred to chamber 758. When second batch 728B becomes saturated within tower 722, it is transferred to chamber 740 in the manner described above. Tower 722 then receives first batch 728A from chamber 758, which has been regenerated and is available for use without further delay.

While preferred embodiments of the present invention are shown and described, it is envisioned that those skilled in the art may devise various modifications of the present invention without departing from the spirit and scope of the appended claims.

We claim:

1. A system for removing an absorbate from a fluid, comprising:
a pump conveying an fluid, said fluid containing an adsorbate;
a removal chamber holding a desiccant and coupled to said pump, said removal chamber receiving said fluid from said pump, said desiccant adsorbing said adsorbate from said fluid to produce an adsorbed desiccant;
a regenerator to de-adsorb said adsorbate from said adsorbed desiccant to produce a regenerated desiccant; and
a pneumatic conveyor coupled to said removal chamber and said regenerator and configured to transport said adsorbed desiccant from said removal chamber to said regenerator and to transport said regenerated desiccant from said regenerator to said removal chamber.

2. The system of claim 1, wherein said pneumatic conveyor further comprises at least one of a pressure-equalization chamber receiving said regenerated desiccant between said regenerator and said removal chamber and a pressure-equalization chamber receiving adsorbed desiccant between said removal chamber and said regenerator.

3. The system of claim 1, wherein said pneumatic conveyor further comprises at least one of a heater and a heat-of-compression dryer.

4. The system of claim 1, wherein said pneumatic conveyor further comprises a storage chamber.

5. The system of claim 1, wherein said fluid is air and said adsorbate is water.

6. The system of claim 1, wherein said pump is a compressor and said fluid is a gas.

7. The system of claim 6, wherein said regenerator and said pneumatic conveyor comprise a venturi.

8. The system of claim 6, wherein said gas is air and said absorbate is water.

9. The system of claim 8, wherein said regenerator and said pneumatic conveyor comprise a venturi.

10. A method for removing an absorbate from a fluid, comprising:
producing a fluid containing an absorbate;
removing said absorbate in a removal chamber by adsorbing said adsorbate onto a desiccant to produce an adsorbed desiccant;
pneumatically conveying said adsorbed desiccant to a regenerator;
de-adsorbing said adsorbate from said adsorbed desiccant to produce a regenerated desiccant; and
pneumatically conveying said regenerated desiccant to said removal chamber.

11. The method of claim 10, further comprising at least one of the step of pneumatically conveying said regenerated desiccant to a pressure-equalization chamber between said regenerator and said removal chamber, and the step of pneumatically conveying said adsorbed desiccant to a pressure-equalization chamber between said removal chamber and said regenerator.

12. The method of claim 10, further comprising heating said adsorbed desiccant before said regenerating step.

13. The method of claim 10, further comprising regenerating said adsorbed desiccant by heat-of-compression drying.

14. The method of claim of claim 10, further comprising the step of storing said regenerated desiccant after said regenerating step.

15. The method of claim 10, wherein said fluid is air.

16. The method of claim 15, wherein said adsorbate is water.

17. The method of claim 10, wherein said de-adsorbing step and said pneumatically conveying steps comprise passing said adsorbed desiccant through a venturi.

18. The method of claim 17, wherein said fluid is air and said absorbate is water.
